(19) United States
(12) Patent Application Publication
(10) Pub. No.: US 2019/0364843 A1
(43) Pub. Date: Dec. 5, 2019

(54) Pet Bed Cover Apparatus, Systems and Methods of Making and Using the Same

(71) Applicant: Karen Murphy, McHenry, IL (US)

(72) Inventor: Karen Murphy, McHenry, IL (US)

(21) Appl. No.: 16/357,026

(22) Filed: Mar. 18, 2019

Related U.S. Application Data
(60) Provisional application No. 62/644,078, filed on Mar. 16, 2018.

(51) Int. Cl. A01K 1/035; A47C 31/10; A47C 31/00

(52) U.S. Cl. CPC A01K 1/0353; A47C 31/005; A47C 31/10

(57) ABSTRACT

The present invention relates to pet bed cover apparatuses and systems. Specifically, the pet bed covers comprise a medical-grade water resistant or water-proof material that is sized and fits over a pet bed to provide a cover for the pet bed. Alternatively, the present invention comprises wipes made from medical-grade material having essential oils embedded therein. Methods of making and using the same are further provided.

The present invention claims priority to U.S. Provisional Pat. App. No. 62/644,078, titled “Pet Bed Cover Apparatus, Systems and Methods of Making and Using the Same,” filed Mar. 16, 2018, which is incorporate herein by reference in its entirety.

### TECHNICAL FIELD

The present invention relates to pet bed cover apparatuses and systems. Specifically, the pet bed covers comprise a medical-grade water resistant or water-proof material that is sized and fits over a pet bed to provide a cover for the pet bed. Alternatively, the present invention comprises wipes made from medical-grade material having essential oils embedded therein. Methods of making and using the same are further provided.

### BACKGROUND

Pet beds are, of course, generally known. Indeed, pet beds, namely for dogs and/or cats, provide a place of comfort and rest for pets and allow the pets to sleep, nap or simply lay comfortably.

Pets, however, often routinely destroy their pet beds, often unintentionally. Pets, such as dogs and cats, may excrete and secrete fluids, odors, feces, and other like material, and oftentimes do so in places where they rest. For example, a dog or a cat that is not litter trained may excrete urine or feces on a pet bed. In addition, pets can become ill and vomit on their beds. Cats are prone to coughing up fur balls due to their constant hygienic practices. Dogs can easily become sick by eating something they are not supposed to. It is common for pets to become ill and vomit on their pet beds. Likewise, animals oftentimes secrete oils and odors that can become trapped on or in pet beds, rendering the pet beds unusable.

In many cases, pet beds must simply be thrown away as they are often difficult to clean effectively. Specifically, to make pet beds comfortable, an outer covering of a soft, absorbent material may be utilized. In addition, absorbent stuffing may be utilized inside the pet beds to form a pad or place for the pet to rest. Excretions and secretions tend to become absorbed by pet beds, both on the absorbent outer covering and internally in the absorbent stuffing.

A need, therefore, exists for improved pet bed cover apparatuses, systems and methods of making and using the same. More specifically, a need exists for improved pet bed cover apparatuses, systems and methods of making and using the same that covers a pet bed and provides a water-resistant and/or water proof barrier between the pet and the pet bed.

Moreover, a need exists for improved pet bed cover apparatuses, systems and methods of making and using the same that is form-fitted over the pet bed. More specifically, a need exists for improved pet bed cover apparatuses, systems and methods of making and using the same that restricts a pet's ability to remove the pet bed cover apparatus from the pet bed due being form-fitted thereon.

In addition, a need exists for improved pet bed cover apparatuses, systems and methods of making and using the same that combats odors that may be excreted or secreted by pets. Further, a need exists for improved pet bed cover apparatuses, systems and methods that include odor neutralizing chemicals that are gentle and safe for pets.

### SUMMARY OF THE INVENTION

The present invention relates to pet bed cover apparatuses and systems. Specifically, the pet bed covers comprise a medical-grade water resistant or water-proof material that is sized and fits over a pet bed to provide a cover for the pet bed. Alternatively, the present invention comprises wipes made from medical-grade material having essential oils embedded therein. Methods of making and using the same are further provided.

To this end, in an embodiment of the present invention, a pet bed liner is provided. The pet bed liner comprises a medical grade material made from a water-resistant and breathable thermoplastic material, sized and configured to take the shape of a resting element, such as a pet bed, and having an elastic strap disposed proximal to an outside edge to cinch the same on the resting element. The pet bed liner may further have a scent embedded therein made from a pure essential oil.

It is, therefore, an advantage and objective of the present invention to provide improved pet bed cover apparatuses, systems and methods of making and using the same.

More specifically, it is an advantage and objective of the present invention to provide improved pet bed cover apparatuses, systems and methods of making and using the same that covers a pet bed and provides a water-resistant and/or water proof barrier between the pet and the pet bed.

Moreover, it is an advantage and objective of the present invention to provide improved pet bed cover apparatuses, systems and methods of making and using the same that is form-fitted over the pet bed.

More specifically, it is an advantage and objective of the present invention to provide improved pet bed cover apparatuses, systems and methods of making and using the same that restricts a pet's ability to remove the pet bed cover apparatus from the pet bed due being form-fitted thereon.

In addition, it is an advantage and objective of the present invention to provide improved pet bed cover apparatuses, systems and methods of making and using the same that combats odors that may be excreted or secreted by pets.

Further, it is an advantage and objective of the present invention to provide improved pet bed cover apparatuses, systems and methods that include odor neutralizing chemicals that are gentle and safe for pets.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a pet bed liner in an embodiment of the present invention.

FIG. 2 illustrates a close-up view of an edge of a pet bed liner in an embodiment of the present invention.

FIG. 3 illustrates a pet bed liner having a pet resting thereon in an embodiment of the present invention.

### DETAILED DESCRIPTION OF THE PRESENTLY PREFERRED EMBODIMENTS

The present invention relates to pet bed cover apparatuses and systems. Specifically, the pet bed covers comprise a medical-grade water resistant or water-proof material that is sized and fits over a pet bed to provide a cover for the pet bed. Alternatively, the present invention comprises wipes made from medical-grade material having essential oils embedded therein. Methods of making and using the same are further provided.

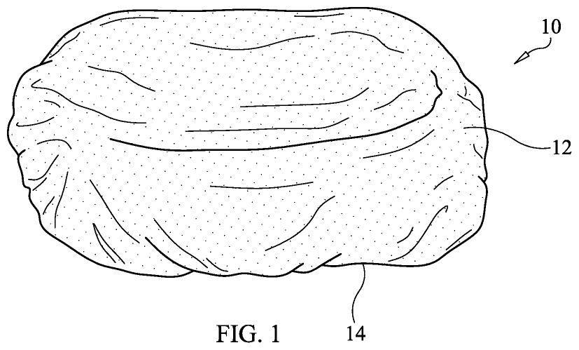

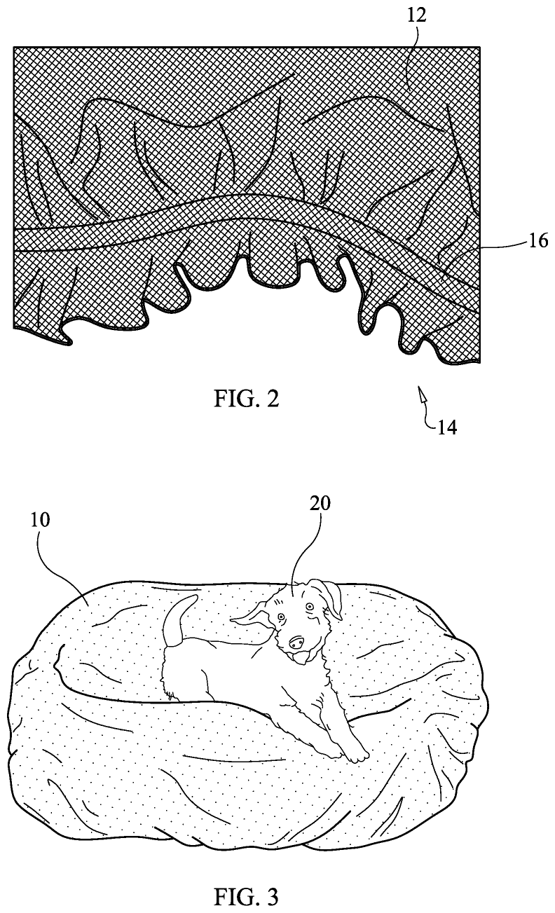

Now referring to FIG. 1, a pet bed liner 10 is illustrated in an embodiment of the present invention. The pet bed liner 10 may be made from a medical grade, water-resistant and/or waterproof material 12 to prevent fluids, such as excretions or secretions from a pet, from soaking therethrough and staining or otherwise absorbing into the pet bed. Thus, the pet bed liner 10 of the present invention protects the pet beds.

The medical grade, water-resistant and/or waterproof material 12 may be made from a thermoplastic spunbond webbing material that resists fluids from flowing therethrough. In a preferred embodiment, the medical grade fabrics are strong, durable, antimicrobial, antistatic, flame resistant, stain, odor, and fluid resistant. The medical grade material may have pore sizes configured to allow air therethrough, but may block fluids from passing therethrough. In a preferred embodiment, the medical grade material 12 is a 35 g/m² non-woven spunbond polypropylene.

The pet bed liner 10 may be shaped to snugly fit over a pet bed so that it remains on the pet bed when a pet rests thereon, and further resists displacement, such as if a pet plays rough on the bed, digs at it, or otherwise attempts to remove it. Disposed around and outside edge 14 of the pet bed liner 10 may be an elastic material 16 that is stitched or otherwise adhered to the outside edge 14 and bunched so that the same provides an elastic cinch that effectively holds the pet bed liner 10 on the pet bed. Thus, a pet 20 may rest on the pet bed without having its oils, or any other secretions or excretions from coming into contact with the pet bed.

Preferably, each pet bed liner 10 is disposable so that if the pet bed liner 10 becomes soiled, it may easily be removed from the pet bed and disposed of. Alternatively, the pet bed liner 10 may be washable in a convention home washing machine.

Scents may further be added to the medical grade material 12 to ensure that the pet bed liner 10 retains a fresh smell after use by a pet. Specifically, the scents may be gentle and subtle, as overpowering scents may cause distress to a pet, especially dogs because they have acute senses of smell. Preferably, scents may be provided by essential oils that may be embedded in the medical grade material 12. The scents may be provided by pure essential oils that are safe and pleasant for pets, thereby both maintaining a pleasant odor on the pet bed liner 10 itself, but also imparting the pleasant odor to the pet as it rests on the pet bed. Example essential oils may preferably include eucalyptus oil and jasmine oil, although any essential oil may be utilized that is safe, pleasant and gentle for pets.

Although the invention is described herein specifically for pet beds, it should be noted that the liners made from the medical grade material 12 may be sized and configured for anything that the pet may rest on, such as couch cushions, chairs, car seats, and other like places for pets to rest. Moreover, the present invention may further be utilized for individuals, and may protect surfaces from soiling, such as due to baby or toddler accidents, adult incontinence, or other like situations, including baby diaper changing stations, sofas, couches, etc.

In an alternate embodiment of the present invention, sheets of the medical grade material 12 may be provided in convenient pouches that may be utilized for wiping on a pet that may have a foul odor, or may otherwise be dirty or soiled, for both cleaning the pet and imparting a pleasant scent. As noted above, pure essential oils may be embedded into the sheets of medical grade material 12 to provide the pleasant and gentle scent that may then be rubbed onto a pet during cleaning of the pet with the sheets of the material 12. Preferably, the essential oils that may be utilized embedded in the wipes may include eucalyptus oil and jasmine oil, although any essential oil or essential oil blend may be utilized that is safe, pleasant and gentle on pets' coats.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

1: A bed liner comprising:
a medical grade material made from a water-resistant and breathable thermoplastic material, sized and configured to take the shape of a resting element and having an elastic strap disposed proximal to an outside edge configured to cinch the same on the resting element.

2: The bed liner of claim 1 further comprising:
a scent embedded therein made from a pure essential oil.

3: The bed liner of claim 2 wherein the scent comprises an essential oil selected from the group consisting of eucalyptus oil, jasmine oil, and combinations thereof.

4: The bed liner of claim 1 wherein the medical grade material comprises spunbond polypropylene.

5: The bed liner of claim 1 wherein the medical grade material comprises spunbond polypropylene weighing 35 g/m².

6: The bed liner of claim 1 wherein the bed liner is sized and configured to be placed over a pet bed, wherein the outside edge of the bed liner is configured to fit around and under the pet bed with the medical grade material forming a surface on a top of the pet bed.

7: The bed liner of claim 1 wherein the bed liner is sized and configured to be placed over a diaper changing table, wherein the outside edge of the bed liner is configured to fit around and under the diaper changing table with the medical grade material forming a surface on a top of the diaper changing table.

8: The bed liner of claim 1 wherein the bed liner is sized and configured to be placed over a seat cushion, wherein the outside edge of the bed liner is configured to fit around and under the seat cushion with the medical grade material forming a surface on a top of the seat cushion.

9: A method of covering a resting element comprising the steps of:
providing a medical grade material made from a water-resistant and breathable thermoplastic material, sized and configured to take the shape of a resting element and having an elastic strap disposed proximal to an outside edge configured to cinch the same on the resting element;
providing a resting element;
stretching the elastic strap on the outside edge of the medical grade material;
disposing the outside edge of the medical grade material around an outer perimeter of the resting element and under the resting element; and
covering a top of the resting element with the medical grade material after disposing the outside edge of the medical grade material around the outer perimeter of the resting element.

10: The method of claim 9 further comprising the step of:
embedding a scent to the medical grade material made from a pure essential oil.

11: The method of claim 10 wherein the scent comprises an essential oil selected from the group consisting of eucalyptus oil, jasmine oil, and combinations thereof.

12: The method of claim 9 wherein the medical grade material comprises spunbond polypropylene.

13: The method of claim 9 wherein the medical grade material comprises spunbond polypropylene weighing 35 g/m2.

14: The method of claim 9 wherein the resting element is a pet bed.

15: The method of claim 9 wherein the resting element is a diaper changing table.

16: The method of claim 9 wherein the resting element is a seat cushion.

17: A wipe for pet fur comprising:
a medical grade material made from a water-resistant and breathable thermoplastic material, the medical grade material comprising spunbond polypropylene.

18: The wipe of claim 17 wherein the medical grade material weighs 35 g/m².

19: The wipe of claim 17 further comprising an essential oil.

20: The wipe of claim 19 wherein the essential oil is selected from the group consisting of eucalyptus oil, jasmine oil, and combinations thereof.
